(19) United States
(12) Patent Application Publication
(10) Pub. No.: US 2015/0176825 A1
(43) Pub. Date: Jun. 25, 2015

(54) Enhancing Visibility

(71) Applicant: Visijax Limited, Stoney Stanton (GB)

(72) Inventor: Mark Jonathan Bernstein, Stoney Stanton (GB)

(21) Appl. No.: 14/561,298

(22) Filed: Dec. 5, 2014

(30) Foreign Application Priority Data
Dec. 24, 2013 (GB) 13 23 058.6

(51) Int. Cl. F21V 23/04; A41D 1/02; F21L 4/08; A41B 1/08; F21V 33/00; F21V 23/00; A41D 1/04; A41D 19/00

(52) U.S. Cl. CPC F21V 23/0471; A41D 1/04; A41D 1/02; A41D 19/0024; A41B 1/08; F21V 33/0008; F21V 23/001; F21V 23/0407; F21L 4/08; F21W 2111/10

(57) ABSTRACT

An item of clothing in the form of a jacket provides enhanced visibility for a cyclist. A right detection device is configured to identify a raising of a right arm and a right indictor light (103) is configured to indicate in response to the raising of the right arm. Similarly, a left detection device is configured to identify the raising of a left arm and a left indicator light 104 is configured to indicate in response to the raising of the left arm. A housing contains a power supply and a control circuit and a pocket is provided in the jacket for supporting the housing. Wires extend from the housing to the detection devices and indicators and these wires are restrained within seams used to construct the jacket.

### CROSS REFERENCE TO RELATED APPLICATIONS

This application claims priority from United Kingdom Patent Application No. 13 23 058.6 filed 24 Dec. 2013, the entire disclosure of which is incorporated herein by reference in its entirety.

### BACKGROUND OF THE INVENTION

1. Field of the Invention

The present invention relates to a wearable item for enhancing visibility.

The present invention also relates to a method of fabricating an item of clothing for enhancing the visibility of a user.

2. Description of the Related Art

It is known to provide apparatus for enhancing the visibility of a user, such as a cyclist. Items may be attached to the cyclist personally or items, such as lights, may be attached to the bicycle.

It is generally accepted that motorists pose the biggest danger to cyclists, particularly on busy roads. Problems exist in terms of making a cyclist and other road users visible.

### BRIEF SUMMARY OF THE INVENTION

According to an aspect of the present invention, there is provided a A wearable item for enhancing visibility, comprising: a plurality of material elements connected by stitched seams; at least one illuminating device which is activated in response to detecting a movement; a source of electrical power; and an electrical conductor for conducting electrical power from said source of electrical power to said illuminating device; wherein a substantial proportion of said electrical conductor is secured within said seams.

In an embodiment, the item is configured substantially as a jacket. In an embodiment, the movement is instigated to indicate an intention to turn.

According to a second aspect of the present invention, there is provided a method of fabricating an item of clothing for enhancing the visibility of a user, comprising the steps of: constructing an illumination system, comprising a right detection device, a left detection device, a right indicator device, a left indicator device, a housing and electrical conductors connecting said housing to said indicator devices; assembling material components, wherein said material components are configured to be joined together by stitches forming a plurality of seams; and securing a least a portion of said electrical conductors within said seams.

In an embodiment, a delay circuit is added configured to maintain the activation of at least one of the indicating devices for a period of time after detecting a movement and means may be added for causing the any one of the indicating devices to flash periodically.

### BRIEF DESCRIPTION OF THE DRAWINGS

FIG. 1 shows an illumination system;

FIG. 2 illustrates a first stage in an assembly process;

FIG. 3 shows a second stage of said assembly process;

FIG. 4 shows a third stage of the assembly process;

FIG. 5 illustrates the construction of a jacket;

FIG. 6 illustrates the application of indicators;

FIG. 7 shows further items added to a jacket;

FIG. 8 illustrates items added to the rear of a jacket;

FIG. 9 illustrates an arm being raised;

FIG. 10 illustrates an activation of an illumination device in response to an arm being raised;

FIG. 11 illustrates continued activation on returning an arm to a control position; and

FIG. 12 illustrates reflectors on the rear of the jacket.

### DETAILED DESCRIPTION OF EXAMPLE EMBODIMENTS

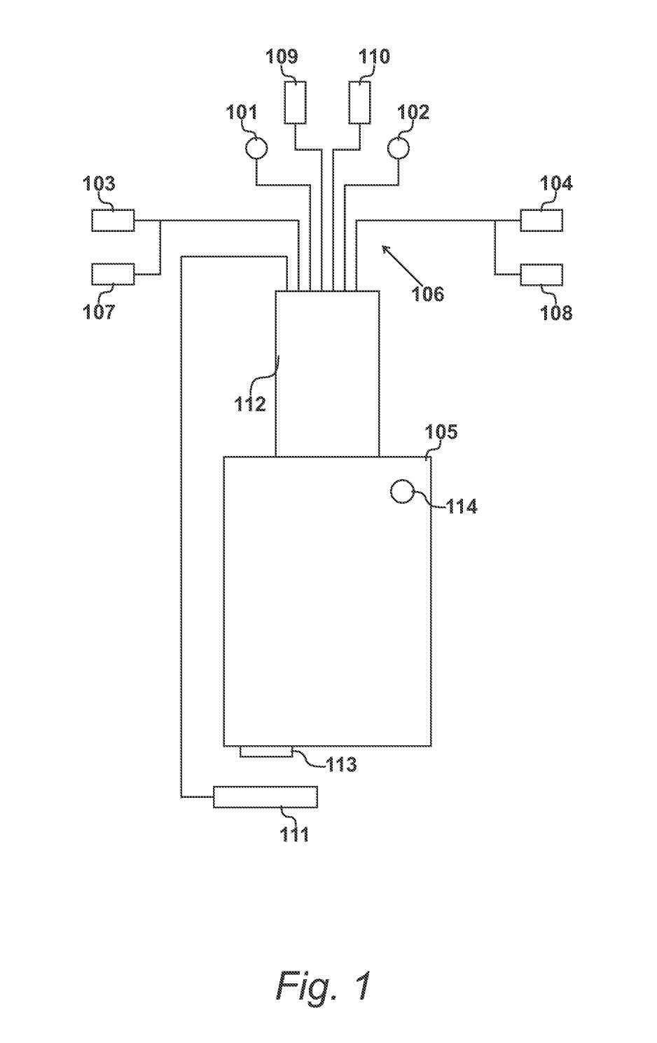

### FIG. 1

An illumination system is illustrated in FIG. 1 that has been constructed with a right detection device 101, a left detection device 102, a right indicator device 103, a left indicator device 104, a housing 105 and a wiring loom 106. The wiring loom connects the housing 105 to the indicator devices 103, 104 and to the detection devices 101, 102.

The illumination system of FIG. 1 is shown as a front view such that, from the perspective of the user, detection device 101 would be on the user's left; but actually shown to the right in FIG. 1.

In use, the raising of a cyclists right arm is detected by detection device 101, possibly taking the form of rocker switch, thereby closing a circuit, such that it is possible for this condition to be detected by circuitry contained within the housing 105. The circuitry will then energize indicating device 103 such that indicating device 103 is seen to flash. In an embodiment, indicating device 103 includes one or more amber colored light emitting diode (LED) devices. Thus, upon raising a right arm, indicator 103 is caused to flash in a way that would be recognizable to a motorist as an indication to the effect that the cyclist intends to turn right.

In an embodiment, a second right indicator 107 is provided, such that the first indicator 103 may be positioned to the front of the jacket and the second indicator 107 may be positioned on the back of the jacket.

Thus, left indicator 104 may be positioned on the front of a jacket, with a second left indictor 108 being positioned on the back of the jacket. Thus, in response to detection device 102 detecting that the left arm has been raised, both LEDs 104 and 108 will be energized such that amber flashes are seen on the left side of the cyclist.

In an embodiment, to improve overall visibility, a first permanent front LED array 109 is provided along with a second permanently lit front array 110.

A permanently lit rear array 111 is also provided, preferably including a plurality of red LED devices.

In an embodiment, the loom 106 is connected to the housing 105 by a detachable plug 112 that may be attached to and then detached from an appropriately configured socket within housing 105.

In addition to housing a control circuit, the housing also contains a battery of energizing cells. These cells may take the form of replaceable cells or they make take the form of rechargeable cells. In the embodiment of FIG. 1, rechargeable cells are included that are recharged via a recharge socket 113. In an embodiment, recharge socket 113 takes the form of a conventional mobile device charging port, such as a USB socket. In this way, it is possible for the rechargeable cells to be recharged using readily available recharging equipment, as used for the charging of other mobile devices such as mobile cellular telephones.

In an embodiment, a toggle button 114 is included for energizing and de-energizing the device manually.

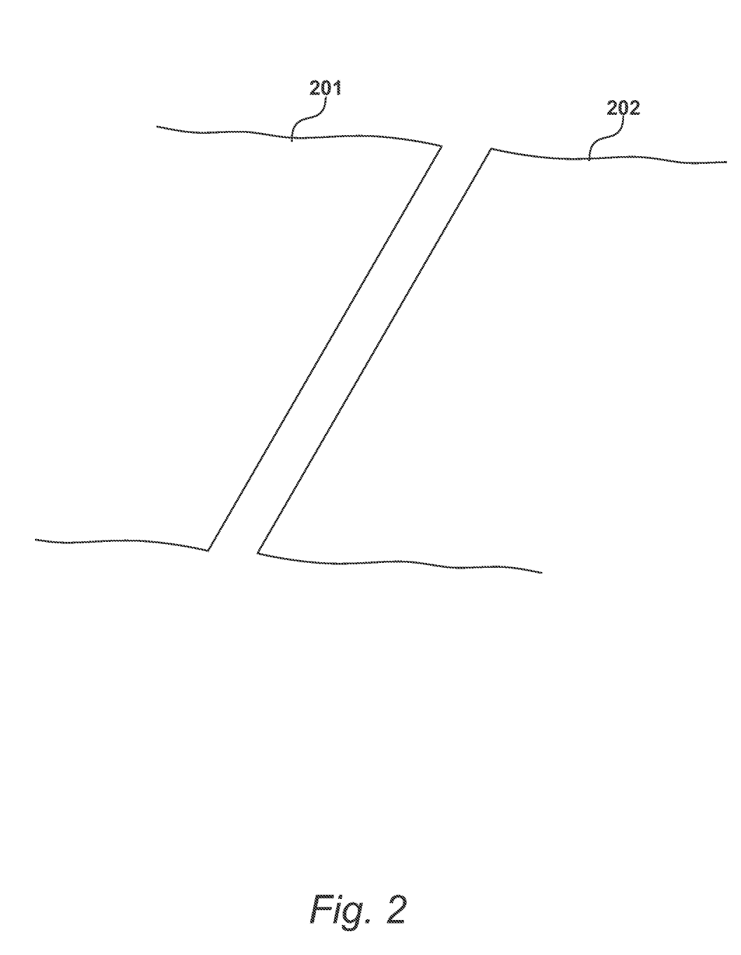

### FIG. 2

In an embodiment, the item of clothing is assembled from material components. As illustrated in FIG. 2, this includes a first material component 201 and a second material component 202. These are configured to be joined together by stitches thereby forming a seam. To construct the jacket, many seams of this type are required. Given that several layers of material are included at the seams, the seams represent a relatively strong region of the jacket, less susceptible to being strained in response to stresses applied thereto during the use of the jacket whilst cycling.

It has been appreciated that wiring loom 106 may become damaged or detached if care is not taken to ensure that the loom is secured to the jacket. Thus, in accordance with the present invention, at least a portion of the wiring loom is secured to the item within one or more of these seams.

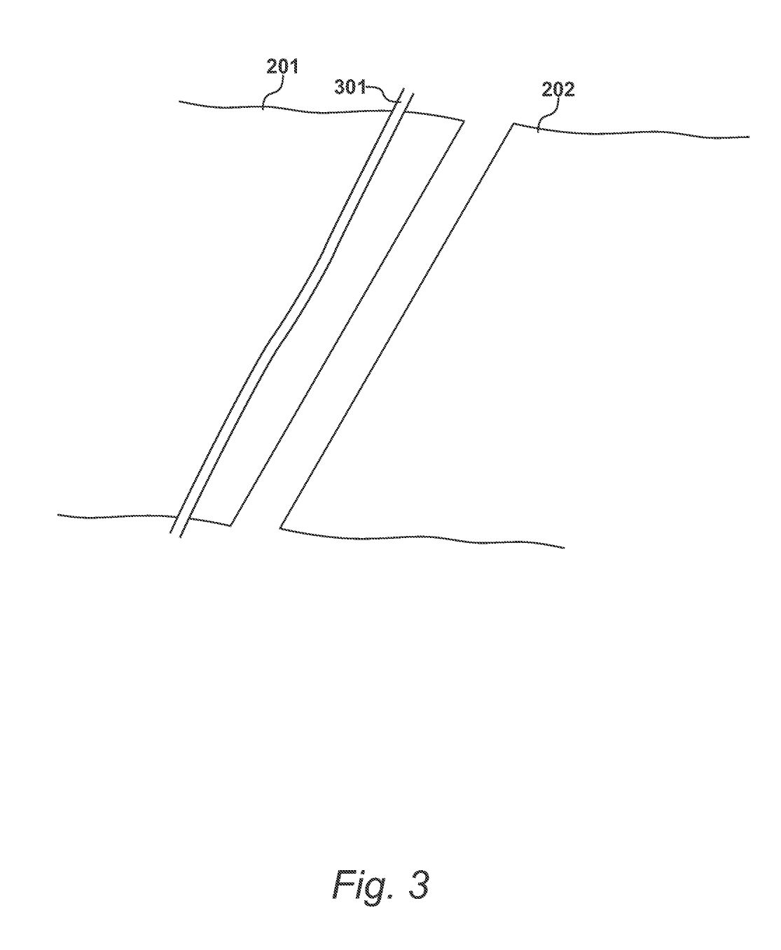

### FIG. 3

Having positioned component 201 in place, alongside material component 202, a portion 301 of the wiring loom 106 is placed over material component 201. In this embodiment, the component 301 is held in place exclusively by the stitching used to connect the individual material components.

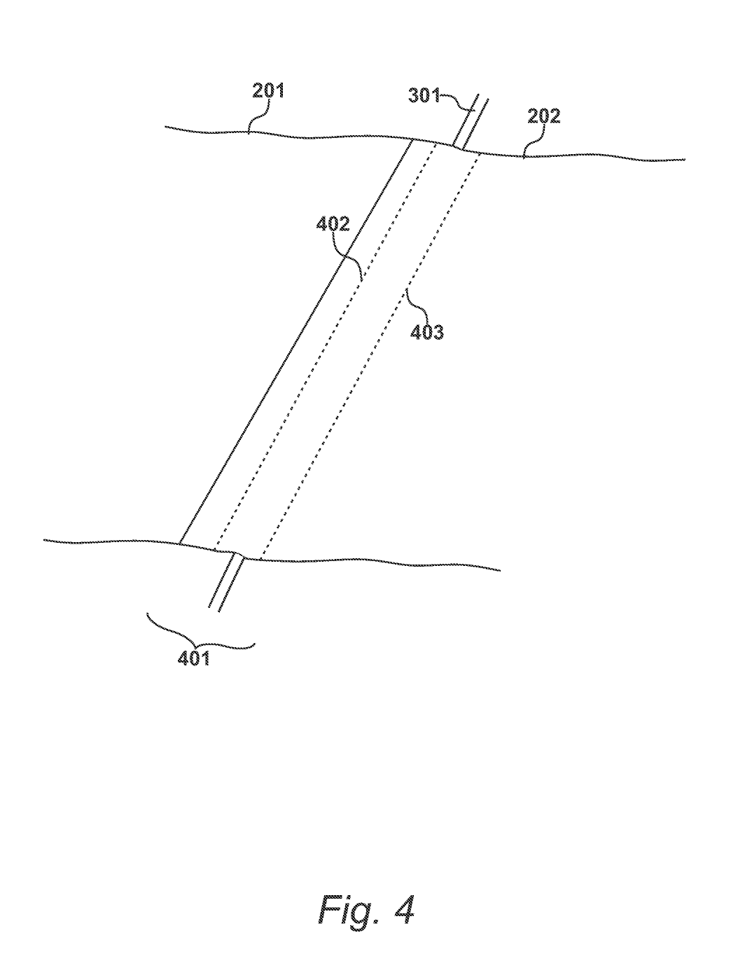

### FIG. 4

Having located section 301 over material component 201, material component 202 is then laid over the combination to provide a region of overlap, indicated by region 401.

A seam is then formed so as to hold material component 201 securely to material component 202 by a first row of stitches 402 and a second row of stitches 403. As shown in FIG. 4, the loom section 301 is held securely between said first row of stitches 402 and said second row of stitches 403. The example shown in FIG. 4 may be considered as a plain seam. In an alternative approach, a French seam is deployed, so that raw edges of the material are fully enclosed.

Thus, in accordance with the invention, the conductor is a wire secured substantially within the seams.

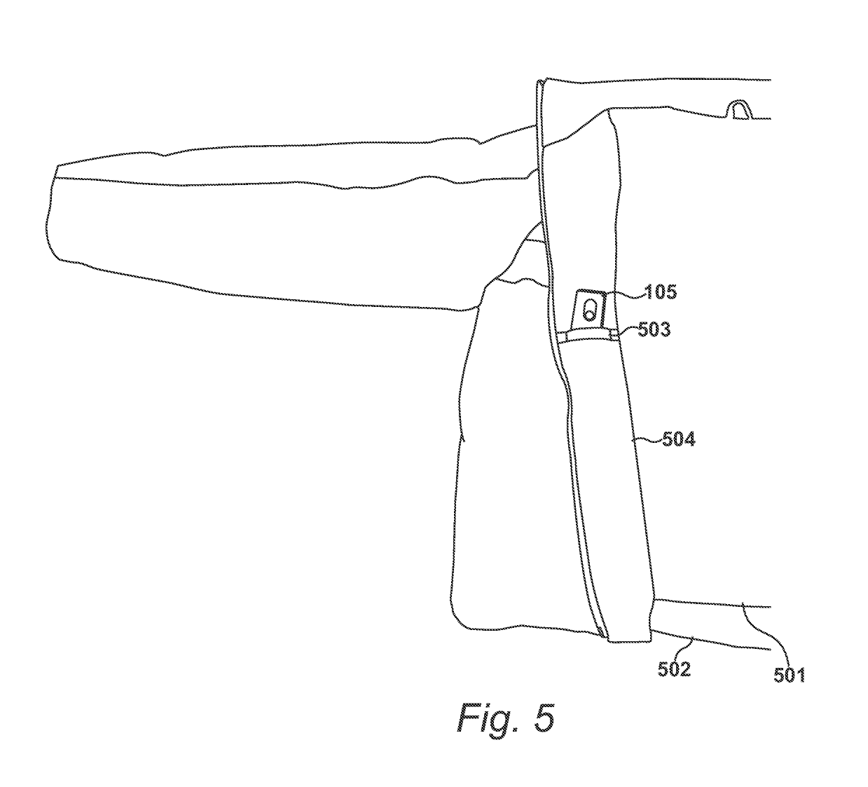

### FIG. 5

In an embodiment, the item of clothing takes the form of a jacket. Furthermore, in an embodiment, the jacket is constructed from a plurality of layers. Thus, an internal layer or mesh 501 may be attached to the external layer 502, possibly using high visibility florescent material, thereby increasing the visibility of the jacket during the daytime.

In an embodiment, the housing 105 is detachable so as to allow the housing to be removed. In an embodiment, the connectors are water resistant, such that is should be possible to remove the housing and thereafter allow the jacket to be washed using conventional washing techniques.

In use, housing 105 may be restrained within a pocket 503 constructed within an internal surface 504 of the jacket.

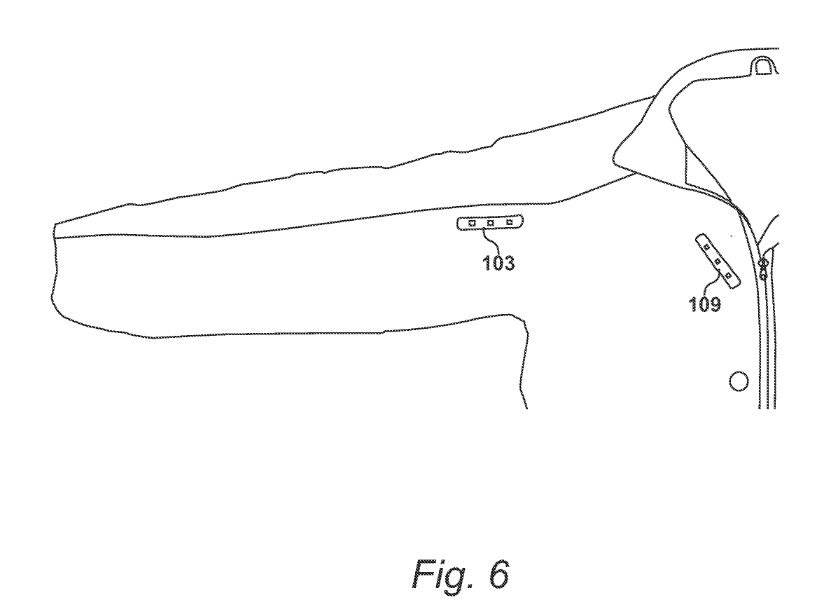

### FIG. 6

Having located the loom 106 within the jacket such that, wherever possible, the wiring loom is secured within seams forming the jacket, it is necessary to connect the detecting devices 101, 102 and the indicating devices 103, 104 etc.

As shown in FIG. 6, indicating device 103 is located on the front upper arm of the jacket. Indicator device 109 is located towards the collar of the jacket.

In this embodiment, each indicator device includes three LED devices configured to emit amber light when energized. Thus, in response to detector 101 detecting that the right arm has been raised, indicator 103 will be energized periodically in order to create a flashing amber light. A similar device, device 107, is provided to the rear of the right arm.

In an embodiment, LED device 109 is configured to emit white light and remains constantly energized to illuminate the cyclist.

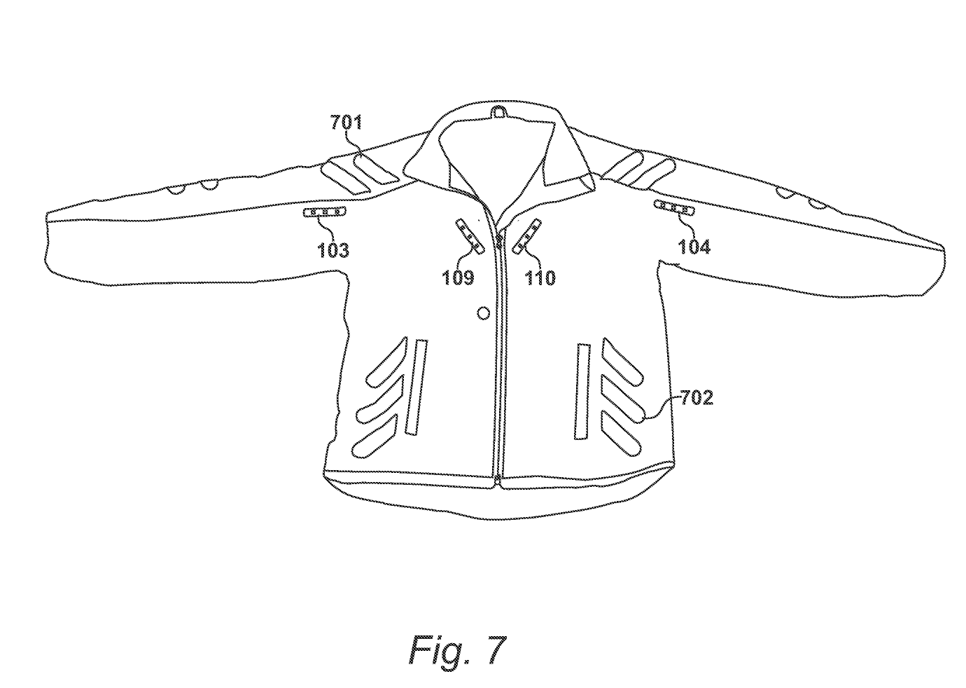

### FIG. 7

Indicating device 103 and illuminating device 109 are also shown in FIG. 7. FIG. 7 shows the full jacket and therefore includes indicating device 104 and illuminating device 110. Each of these devices has been attached to the jacket and in an embodiment, the devices comprise a plurality of light emitting diodes.

In this embodiment, reflective materials 701 have been added to the arms and similar reflective materials 702 have been added to the torso. These reflective materials 701, 702 improve night time visibility and may include retro-reflective materials.

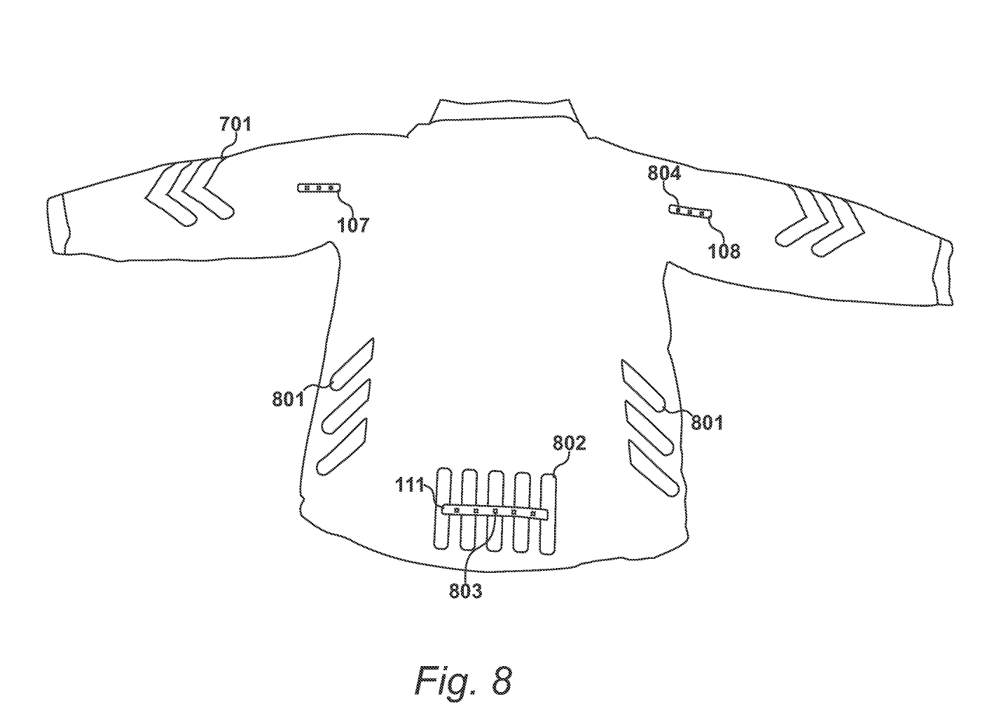

### FIG. 8

The rear of the jacket shown in FIG. 7 is illustrated in FIG. 8. Rear reflective elements 801 are included to the sides of the jacket and additional reflective elements 802 are included towards the bottom of the jacket. Illuminator 111 is also included towards the bottom of the jacket and comprises, in this example, five LED devices 803 configured to emit red light.

FIG. 8 also illustrates the position of the left rear indicator 107 and the right rear indicator 108. Again, the left rear indicator 107 and the right rear indicator 108 include, in this example, three LED devices 804 configured to emit amber light. Thus, when the left arm is raised, indicator 107 will flash and when the right arm is raised, indicator 108 will flash.

The jacket is an example of a wearable item for enhancing visibility and the invention could be applied to other items, such as a vest, a shirt, a jacket, a glove or a rucksack. Material elements are connected together by stitched seams and at least one illuminating device is provided along with a source of electrical power. A conductor conducts electrical power from the source of electrical power to the illuminating device and a substantial portion of the conductor is secured within the seams.

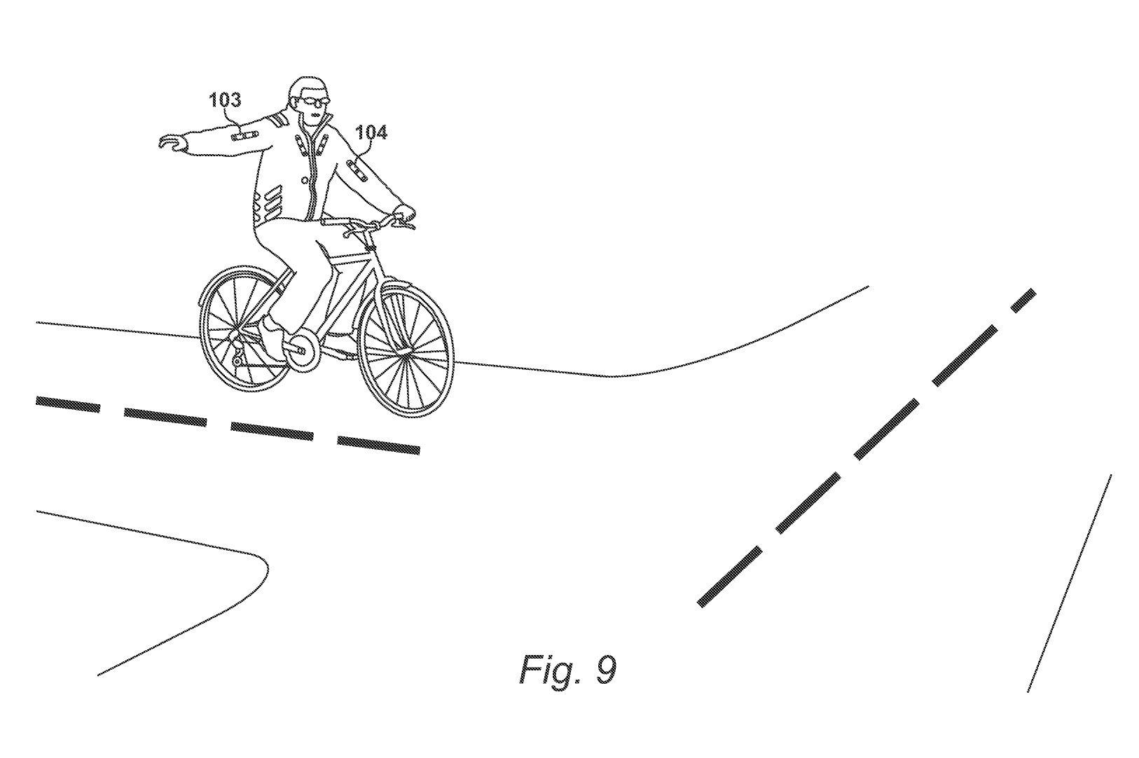

### FIG. 9

A jacket for enhancing the visibility of a user is shown, in use, in FIG. 9. Right detection device 101 identifies the raising of a right arm. Right indicator light 103 is configured to indicate in response to identifying the right arm being raised. Similarly, left detection device 102 is configured to identify the raising of the left arm. The left indicator device 104 is configured to indicate in response to identifying the raising of the left arm.

The housing 105 contains the power supply and the control circuit and remains protected, when the jacket is closed, although allowing easy access in order for the device to be energized or de-energized by the activation of toggle button 104.

As described with reference to FIGS. 2 to 5, wires connect the housing to the detection devices and the indicators; and these wires are restrained within seams sewn into the item. As shown in FIG. 9, the item of clothing may, in an embodiment, take the form of a jacket.

In an embodiment, the detection devices 101, 102 include mechanical devices such that each mechanical device is moveable between a first position, as shown by the left arm in FIG. 9, and a second position, when an arm is raised to indicate an intention to turn, as shown by the right arm in FIG. 9.

Thus, in response to the right arm being raised as shown in FIG. 9, indicator 103, comprising a plurality of light emitting diodes, emits light indicating that the cyclist wishes to turn right. To be consistent with accepted practice for motor vehicles, the indicator lights may be amber and may flash periodically.

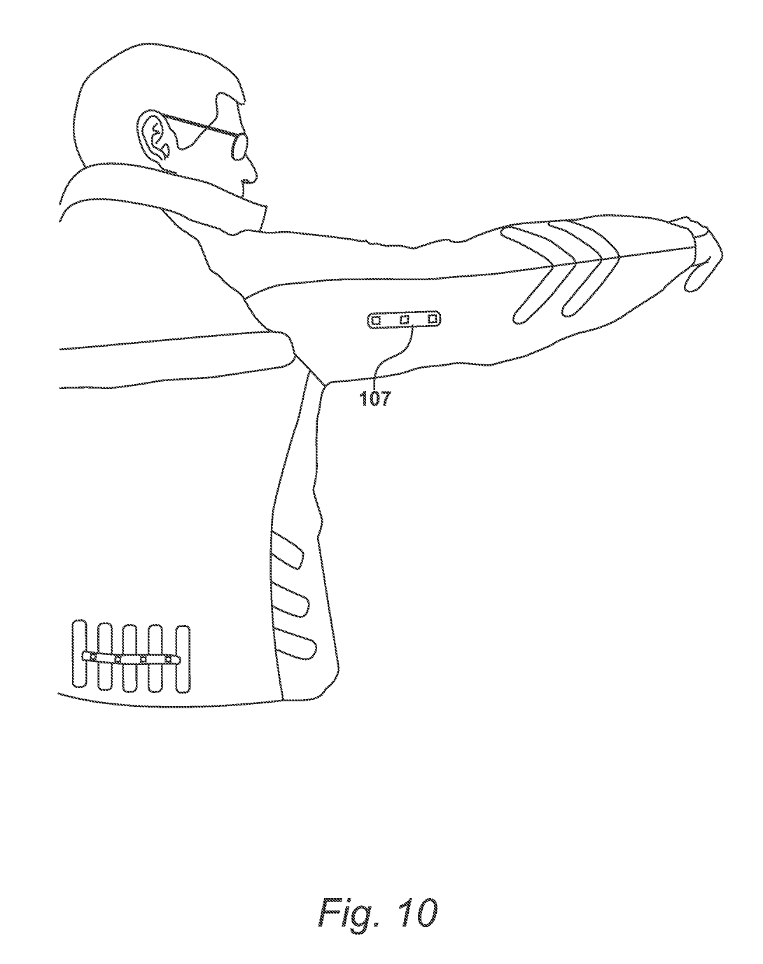

### FIG. 10

As the right arm is raised, indicator 103 will flash amber; in a preferred embodiment, a similar indicator 107 on a rear portion of the arm will also flash. Thus, in this way, the indication can be seen by a motorist approaching the cyclist from the front or approaching the cyclist from behind.

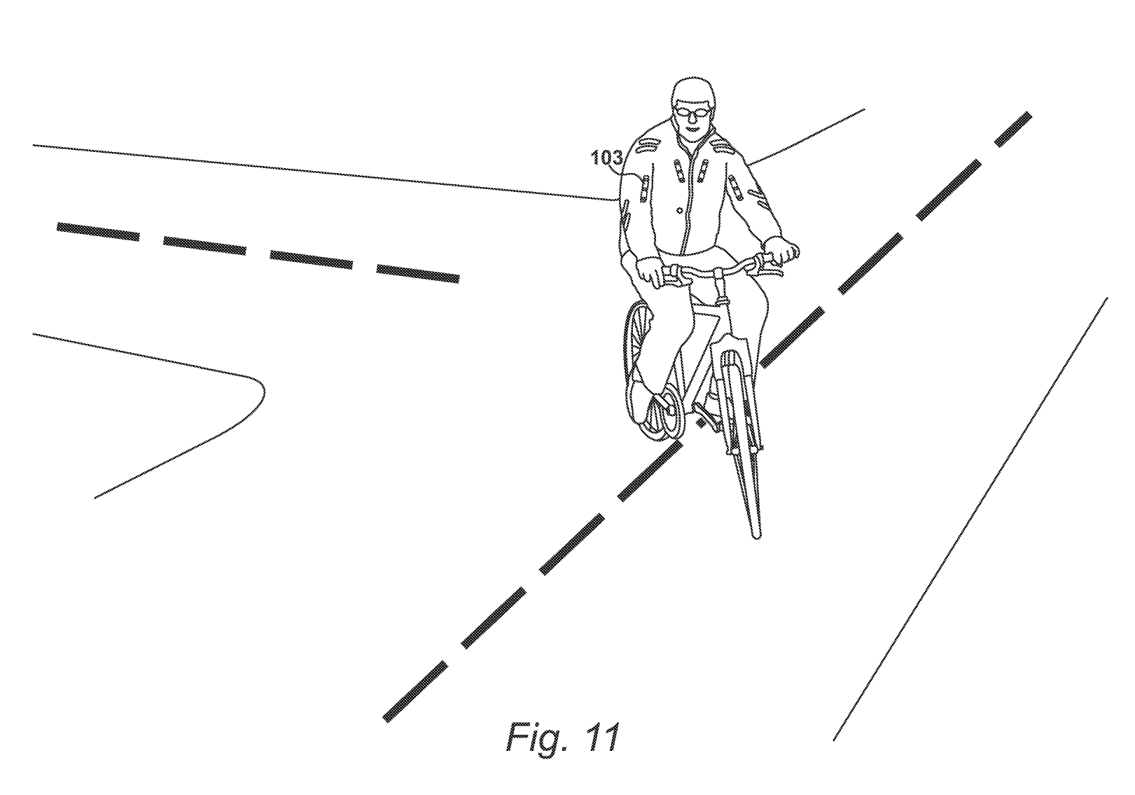

### FIG. 11

In accordance with accepted practice, a cyclist will raise an arm indicating an intention to turn in the direction of the raised arm. In order to perform the maneuver, the cyclist would usually return their raised arm to the handlebars, as illustrated in FIG. 11. In an embodiment, a delay or monostable circuit is provided such that, for a period of time (possibly ten seconds), indicator 103 continues to flash after the right arm has been returned to the handlebars. Thus, as the cyclist turns, the indicator continues to flash.

Given that it is desirable for this flashing to continue, for the duration of the turn, it is preferable to locate indicator 103 towards the top of the arm in preference to being around the position of the wrist. Thus, while a position at the wrist would be desirable when the arm is extended, as illustrated in FIG. 9, it is preferable for the indicator to be higher up the arm when the hand is returned to the handlebars, as illustrated in FIG. 11. However, in an alternative embodiment, it would be possible to include indicators at both locations.

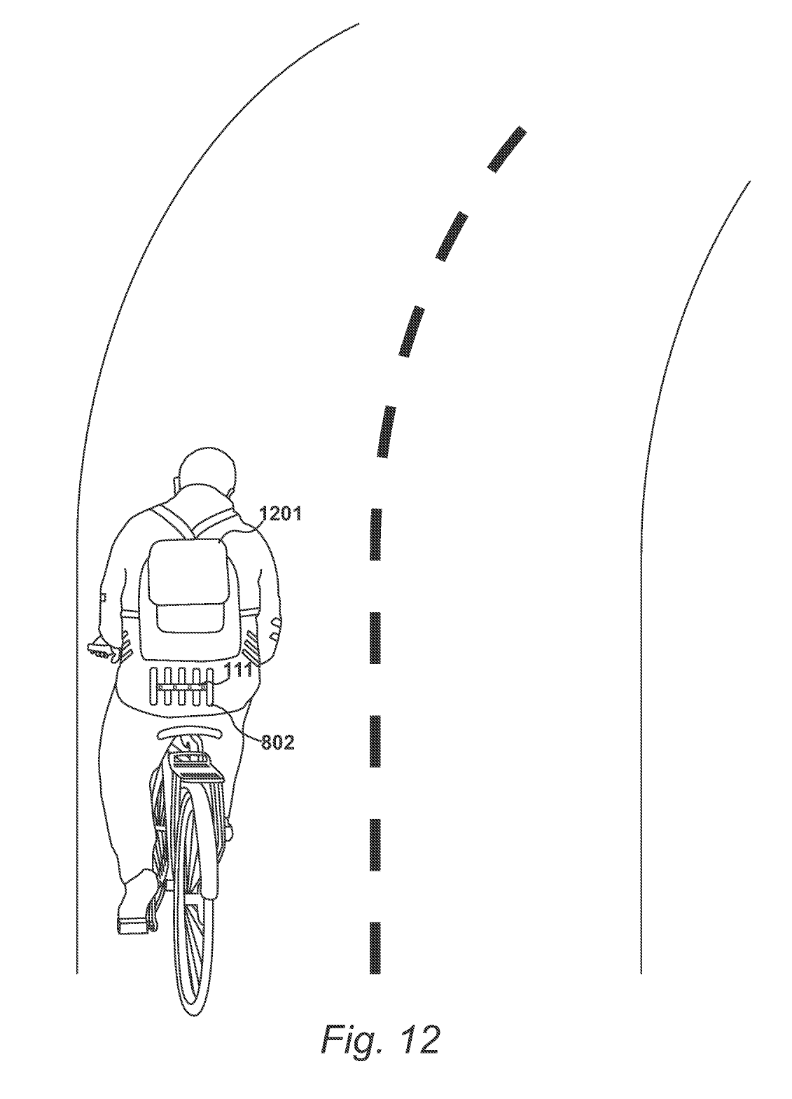

### FIG. 12

As described with reference to FIG. 8, rear reflector 802 and rear illuminator 111 are positioned towards the bottom of the jacket. Again, in some applications, it may be preferable to position indicator 111 higher up, such that its visibility to motorists is optimized. However, in the embodiment of FIG. 12, indicator 111 is positioned towards the bottom of the jacket such that the user may carry a rucksack 1201 or similar item without obscuring indicator 111.

A wearable item has been described for use by cyclists. However, it should be appreciated that other situations may arise for alternative users being provided with a wearable item having at least one illuminating device thereby enhancing the visibility of the user. Thus, wearable items of this type could be used for other sporting activities or other manual activities performed in the vicinity of motor vehicles.

What we claim is:

1. A wearable item for enhancing visibility, comprising:
a plurality of material elements connected by stitched seams;
at least one illuminating device which is activated in response to detecting a movement;
a source of electrical power; and
an electrical conductor for conducting electrical power from said source of electrical power to said illuminating device; wherein
a substantial proportion of said electrical conductor is secured within said seams.

2. The wearable item of claim 1, wherein said item is non-exclusively selected from a list comprising: a vest, a shirt, a jacket, a glove and a rucksack.

3. The wearable item of claim 1, wherein said movement is instigated to indicate an intention to turn.

4. The wearable item of claim 3, wherein said movement involves the raising of an arm.

5. The wearable item of claim 1, comprising:
a right detection device configured to identify a raising of a right arm;
a right indicator light configured to indicate in response to said raising of said right arm;
a left detection device configured to identify a raising of a left arm; and
a left indicator light configured to indicate in response to said raising of said left arm.

6. The wearable item of claim 5, wherein said detection devices include a mechanical device, said mechanical device being movable between:
a first position, when an arm is positioned to allow contact with a steering mechanism; and
a second position, when an arm is raised to indicate an intention to turn.

7. The wearable item of claim 6, wherein said mechanical device is a rocker switch.

8. The wearable item of claim 1, further comprising a delay circuit configured to maintain the activation of said illuminating device for a period of time after detecting a movement.

9. The wearable item of claim 1, including means for causing said illuminating device to flash periodically.

10. A method of fabricating a wearable item for enhancing the visibility of a user, comprising the steps of:
constructing an illumination system, comprising a right detection device, a left detection device, a right indicator device, a left indicator device, a housing and electrical conductors connecting said housing to said indicator devices;
assembling material components, wherein said material components are configured to be joined together by stitches forming a plurality of seams; and
securing a least a portion of said electrical conductors within said seams.

11. The method of claim 10, wherein said item is constructed from a plurality of layers.

12. The method of claim 11, wherein an outer layer is formed from a high visibility material.

13. The method of claim 10, including the step of attaching reflective elements.

14. The method of claim 10, including the step of adding additional illuminating components.

15. The method of claim 14, wherein said additional illuminating components are added to a lower back position.

16. The method of claim 10, further comprising the step of connecting said loom to said housing by a de-connectable connector to facilitate the removal of said housing.

17. The method of claim 10, wherein: said housing is inserted into a pocket in said item; and
said housing is removable from said pocket.

18. The method of claim 10, including the step of adding a delay circuit configured to maintain the activation of at least one of said indicator devices for a period of time after detecting a movement.

19. The method according to claim 10, including means for causing at least one of said indicator devices to flash periodically.
